(19) United States
(12) Patent Application Publication
(10) Pub. No.: US 2018/0129440 A1
(43) Pub. Date: May 10, 2018

(54) SELF-VIRTUALIZING FLASH MEMORY FOR SOLID STATE DRIVE

(71) Applicant: Western Digital Technologies, Inc., Irvine, CA (US)

(72) Inventors: Zvonimir Z. Bandic, San Jose, CA (US); Seung-Hwan Song, San Jose, CA (US); Chao Sun, San Jose, CA (US); Minghai Qin, San Jose, CA (US); Dejan Vucinic, San Jose, CA (US)

(21) Appl. No.: 15/347,472

(22) Filed: Nov. 9, 2016

(51) Int. Cl. G06F 3/06

(52) U.S. Cl. CPC G06F 3/0634; G06F 3/0679; G06F 3/0667; G06F 3/0604

(57) ABSTRACT

In general, a controller may perform a self-virtualization technique. The storage device may include storage access comprising multiple cells, and a controller. The controller may determine a maximum amount of storage access for a virtual machine workload when each cell is configured in a first level mode having a maximum allowable number of bits per cell. The controller may configure each cell to be in a second level mode having a number of bits per cell less than the maximum. The controller may determine a total number of bits in use in each cell and compare this total to a threshold number of bits in use in each cell. Based on the comparison, the controller may reconfigure one or more cells to be in a third level mode having a number of bits per cell greater than the number for the second level mode.

### TECHNICAL FIELD

The disclosure relates to data storage management.

### BACKGROUND

Solid-state drives (SSDs) may be used in computers in applications where relatively low latency and high performance storage are desired. SSDs may utilize multiple, parallel data channels to read from and write to memory devices, which may result in high sequential read and write speeds.

SSDs may utilize non-volatile memory (NVM) devices, such as flash memory, phase change memory (PCM), resistive random access memory (ReRAM), magnetoresistive random access memory (MRAM) devices, or the like. In some examples, each memory device includes multiple memory cells arranged in pages, and each block includes multiple pages. Each cell of the memory device may be configured to store a different number of bits depending on the level mode of the particular cell. In addition to storage differences, the different level modes may have varying degrees of efficiency, reliability, and security.

In I/O virtualization, single root input/output virtualization (SR-IOV) is an interface configured to provide isolation of the peripheral component interconnect (PCI®) express resources for manageability and performance reasons. SR-IOV supports direct paths from virtual machines to input/output devices, removing software overhead from a hypervisor, thereby potentially isolating the performance for the devices while still preserving fairness on virtual machine resource allocation.

### SUMMARY

In one example, the disclosure is directed to a method that includes determining, by a controller, a maximum amount of storage access for a virtual machine workload on a solid state drive (SSD) when each cell in the storage access is configured in a first level mode. Each cell in the storage access being configured in the first level mode comprises each cell in the storage access having a maximum allowable number of bits per cell. The method further includes configuring, by the controller, each cell in the storage access for the virtual machine to be in a second level mode. Each cell in the storage access being configured in the second level mode comprises each cell in the storage access having a number of bits per cell less than the maximum allowable number of bits per cell. The method also includes determining, by the controller, a total number of bits in use in each cell of the storage access. The method further includes comparing, by the controller, the total number of bits in use in each cell of the storage access to a threshold number of bits in use in each cell of the storage access. The method also includes based on the comparison, reconfiguring, by the controller, one or more cells in the storage access for the virtual machine to be in a third level mode. The one or more cells in the storage access being configured in the third level mode comprises each cell in the storage access having a number of bits per cell greater than the number of bits per cell for the second level mode.

In another example, the disclosure is directed to a storage device including a storage access comprising a plurality of cells, and a controller. The controller is configured to determine a maximum amount of storage access for a virtual machine workload when each cell in the storage access is configured in a first level mode. Each cell in the storage access being configured in the first level mode comprises each cell in the storage access having a maximum allowable number of bits per cell. The controller is further configured to configure each cell in the storage access for the virtual machine to be in a second level mode. Each cell in the storage access being configured in the second level mode comprises each cell in the storage access having a number of bits per cell less than the maximum allowable number of bits per cell. The controller is also configured to determine a total number of bits in use in each cell of the storage access. The controller is further configured to compare the total number of bits in use in each cell of the storage access to a threshold number of bits in use in each cell of the storage access. The controller is also configured to, based on the comparison, reconfigure one or more cells in the storage access for the virtual machine to be in a third level mode. The one or more cells in the storage access being configured in the third level mode comprises each cell in the storage access having a number of bits per cell greater than the number of bits per cell for the second level mode.

In another example, the disclosure is directed to a computer-readable storage medium storing instructions that, when executed, cause a controller of a storage device to determine a maximum amount of storage access for a virtual machine workload on a solid state drive (SSD) when each cell in the storage access is configured in a first level mode. Each cell in the storage access being configured in the first level mode comprises each cell in the storage access having a maximum allowable number of bits per cell. The instructions further cause the controller to configure each cell in the storage access for the virtual machine to be in a second level mode. Each cell in the storage access being configured in the second level mode comprises each cell in the storage access having a number of bits per cell less than the maximum allowable number of bits per cell. The instructions also cause the controller to determine a total number of bits in use in each cell of the storage access. The instructions further cause the controller to compare the total number of bits in use in each cell of the storage access to a threshold number of bits in use in each cell of the storage access. Based on the comparison, the instructions further cause the controller to reconfigure one or more cells in the storage access for the virtual machine to be in a third level mode. The one or more cells in the storage access being configured in the third level mode comprises each cell in the storage access having a number of bits per cell greater than the number of bits per cell for the second level mode.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual and schematic block diagram illustrating an example system including a storage device connected to a host device, where the storage device is configured to perform self-virtualization based on memory usage, in accordance with one or more techniques of this disclosure.

FIG. 2 is a conceptual block diagram illustrating an example memory device in a storage device, in accordance with one or more techniques of this disclosure.

FIG. 3 is a conceptual and schematic block diagram illustrating an example controller configured to perform self-virtualization based on memory usage, in accordance with one or more techniques of this disclosure.

FIG. 4A is a conceptual and schematic block diagram illustrating example details of a memory device containing data blocks grouped by a controller into storage accesses for the self-virtualization process, in accordance with one or more techniques of this disclosure.

FIG. 4B is another conceptual and schematic block diagram illustrating example details of a memory device containing data blocks grouped by a controller into storage accesses for the self-virtualization process, in accordance with one or more techniques of this disclosure.

FIG. 4C is a diagram outlining performance level and physical capacity utilization for each virtual machine for storage accesses configured in various level cell modes in accordance with one or more techniques of this disclosure.

FIG. 4D is a conceptual diagram illustrating various voltage groups in different level cell modes, in accordance with one or more techniques of this disclosure.

FIG. 5 is a flow diagram illustrating example self-virtualization operations performed by a controller of a storage device, in accordance with one or more techniques of this disclosure.

FIG. 6 is a flow diagram illustrating more detailed example self-virtualization operations performed by a controller of a storage device, in accordance with one or more techniques of this disclosure.

### DETAILED DESCRIPTION

The disclosure describes techniques for performing self-virtualization during single root input/output virtualization (SR-IOV) for a storage device, such as a solid state drive (SSD), which may help increase the operating efficiency of the storage device during the course of regular data processing. During the self-virtualization process, the storage device may dynamically alter the number of bits that each cell in a storage access may be configured to store based on storage availability throughout the storage access.

The storage device may include storage access, a virtual machine connected with the storage access, and a controller. The storage access may include multiple blocks of data, and each block of data may be divided into multiple pages of data. Each page of data may further be divided into multiple cells of data. Further, each cell of the data may be configured to store a different number of bits depending on the level mode of the particular cell.

The controller may determine a maximum amount of storage access for the virtual machine when each cell in the storage access is configured in a first level mode, or when each cell in the storage access stores a maximum allowable number of bits per cell (e.g., 3 bits per cell, such as in a triple-level cell (TLC) mode). The controller may then configure each cell in the storage access for the virtual machine to be in a second level mode, or when each cell in the storage access stores a number of bits per cell less than the maximum (e.g., 1 bit per cell, such as in a single-level cell (SLC) mode).

At some point, such as during a garbage collection process, the controller may determine a total number of bits in use in each cell of the storage access and compare this total to a threshold number of bits in use in each cell of the storage access. Based on the comparison, the controller may reconfigure one or more cells in the storage access to be in a third level mode, or for each cell in the storage access to store a number of bits per cell greater than the number for the second level mode (e.g., 2 bits per cell, such as in a multiple-level cell (MLC) mode).

When a cell is in SLC mode, the capacity for the cell may only be one-third of the capacity in TLC mode, but a controller may have faster read and write speeds with less stress to the SLC cell. When the cell is in MLC mode, the capacity is twice as large as the SLC cell, but the controller may still have faster read and write speeds with less stress to the MLC cell than if the cell was in TLC mode. In some examples of this disclosure, a single SSD may include multiple storage accesses: One or more storage accesses in SLC mode, one or more storage accesses in MLC mode, and one or more storage accesses in TLC mode. Each storage access may correspond to a particular virtual machine workload. However, every storage access may be capable of being configured to operate in TLC mode.

Virtual machines from the host may be grouped into three categories: high-priority, middle-priority and low-priority. High-priority virtual machines may be utilized when the host is running a processing-heavy workload, and, thus, requests low response from the storage device. Middle-priority virtual machines may be utilized when the host is editing previously written data. Low-priority virtual machines may be utilized when the host is performing back-up procedures, which do not request fast response times and do not require high throughput.

Based on a tag from the virtual machine, the SSD controller may assign the SLC storage accesses to high-priority guests, MLC storage accesses to middle-priority guests, and TLC storage accesses to low-priority guests. When an SLC storage access or MLC storage access is storing enough data that the number of stored bits in the storage access surpasses the threshold number of bits, the controller may reconfigure one or more cells in the SLC or MLC storage access to be in a slower, higher capacity level mode (e.g., reconfiguring an SLC cell to be an MLC cell, or reconfiguring an MLC cell to be a TLC cell).

Rather than statically forcing the cells in the storage access to store a certain number of bits, the techniques described herein may place cells in various level modes together within an SSD by differently applying a number of verify and read reference levels. Hardware partitioning techniques may be simple, but are rigid and may under-utilize parallelism within the SSD. In accordance with the techniques described herein, three general levels of service may be provided to the guest device. That is, the controller may provide SLC-level quality, MLC-level quality, and TLC-level quality to the guest devices accessing the SSD. Multiple types of cells may exist in dies of the SSD, which may ensure that a guest device may utilize the maximum possible bandwidth provided by the three separate groups for performance isolation.

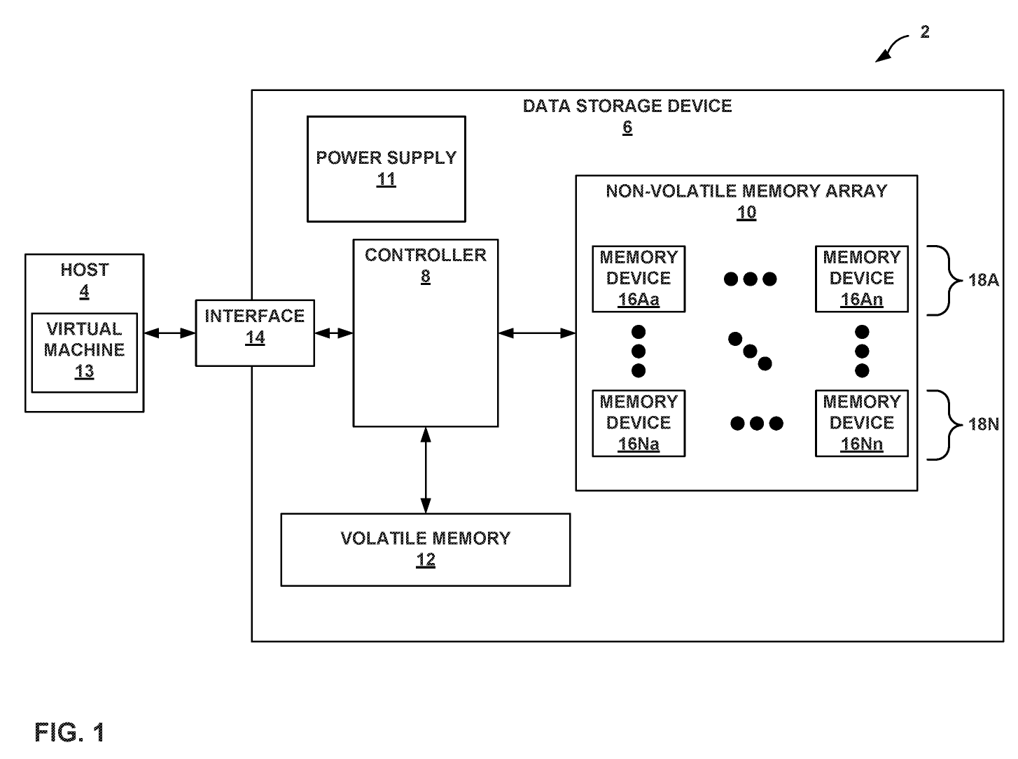

FIG. 1 is a conceptual and schematic block diagram illustrating an example system 2 including a storage device 6 connected to a host device 4, where storage device 6 is configured to perform self-virtualization based on memory usage, in accordance with one or more techniques of this disclosure. For instance, host device 4 may utilize non-volatile memory devices included in storage device 6 to store and retrieve data. In some examples, storage environment 2 may include a plurality of storage devices, such as storage device 6, which may operate as a storage array. For instance, storage environment 2 may include a plurality of storages devices 6 configured as a redundant array of inexpensive/independent disks (RAID) that collectively function as a mass storage device for host device 4.

Storage environment 2 may include host device 4 which may store data to and/or retrieve data from one or more storage devices, such as storage device 6. As illustrated in FIG. 1, host device 4 may communicate with storage device 6 via interface 14. Host device 4 may include any of a wide range of devices, including computer servers, network attached storage (NAS) units, desktop computers, notebook (i.e., laptop) computers, tablet computers, set-top boxes, telephone handsets such as so-called “smart” phones, tablet computers, televisions, cameras, display devices, digital media players, video gaming consoles, video streaming device, and the like.

As illustrated in FIG. 1, storage device 6 may include controller 8, non-volatile memory array 10 (NVMA 10), power supply 11, volatile memory 12, and interface 14. In some examples, storage device 6 may include additional components not shown in FIG. 1 for sake of clarity. For example, storage device 6 may include a printed board (PB) to which components of storage device 6 are mechanically attached and which includes electrically conductive traces that electrically interconnect components of storage device 6, or the like. In some examples, the physical dimensions and connector configurations of storage device 6 may conform to one or more standard form factors. Some example standard form factors include, but are not limited to, 3.5″ hard disk drive (HDD) or SSD, 2.5″ HDD or SSD, 1.8″ HDD or SSD, peripheral component interconnect (PCI®), PCI®-extended (PCI®-X), PCI® Express (PCIe) (e.g., PCIe x1, x4, x8, x16, PCIe Mini Card, MiniPCI®, etc.), M.2, or the like. In some examples, storage device 6 may be directly coupled (e.g., directly soldered) to a motherboard of host device 4.

Storage device 6 may include interface 14 for interfacing with host device 4. Interface 14 may include one or both of a data bus for exchanging data with host device 4 and a control bus for exchanging commands with host device 4. Interface 14 may operate in accordance with any suitable protocol. For example, interface 14 may operate in accordance with one or more of the following protocols: advanced technology attachment (ATA) (e.g., serial-ATA (SATA), and parallel-ATA (PATA)), Fibre Channel, small computer system interface (SCSI), serially attached SCSI (SAS), peripheral component interconnect (PCI®), PCI®-express (PCIe®), Non-Volatile Memory Express (NVMe™), or the like. The electrical connection of interface 14 (e.g., the data bus, the control bus, or both) is electrically connected to controller 8, providing electrical connection between host device 4 and controller 8, allowing data to be exchanged between host device 4 and controller 8. In some examples, the electrical connection of interface 14 may also permit storage device 6 to receive power from host device 4.

Storage device 6 includes NVMA 10, which includes a plurality of memory devices 16Aa-16Nn (collectively, “memory devices 16”). Each of memory devices 16 may be configured to store and/or retrieve data. For instance, a memory device of memory devices 16 may receive data and a message from controller 8 that instructs the memory device to store the data. Similarly, the memory device of memory devices 16 may receive a message from controller 8 that instructs the memory device to retrieve data. In some examples, each of memory devices 16 may be referred to as a die. In some examples, a single physical chip may include a plurality of dies (i.e., a plurality of memory devices 16). In some examples, each of memory devices 16 may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, memory devices 16 may include any type of non-volatile memory devices. Some examples of memory devices 16 include, but are not limited to, flash memory devices (e.g., NAND or NOR), phase-change memory (PCM) devices, resistive random-access memory (ReRAM) devices, magnetoresistive random-access memory (MRAM) devices, ferroelectric random-access memory (F-RAM), holographic memory devices, and any other type of non-volatile memory devices.

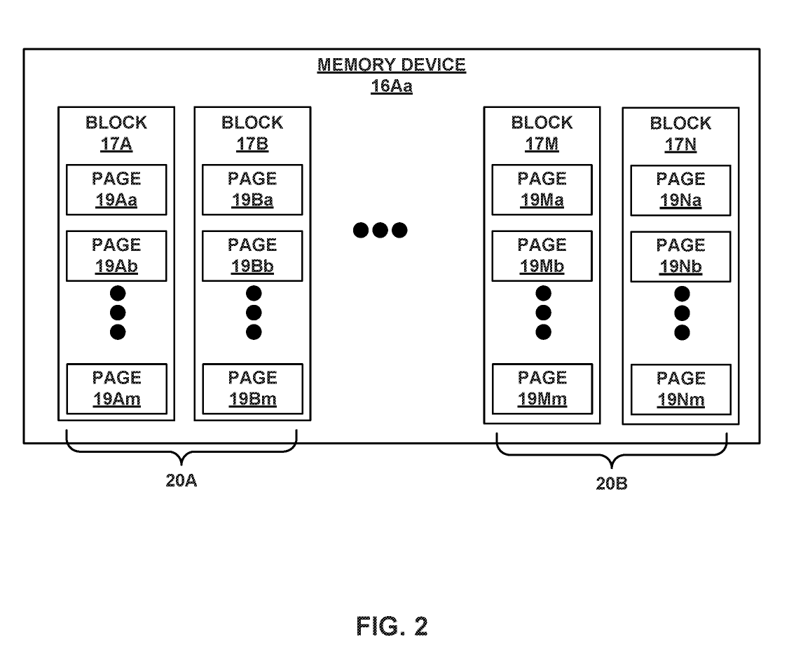

In some examples, memory devices 16 may include flash memory devices. Flash memory devices may include NAND or NOR based flash memory devices, and may store data based on a charge contained in a floating gate of a transistor for each flash memory cell. In NAND flash memory devices, the flash memory device may be divided into a plurality of blocks, each of which may be divided into a plurality of pages. Each page of the plurality of pages within a particular memory device may include a plurality of NAND cells. Rows of NAND cells may be electrically connected using a word line to define a page of a plurality of pages. Respective cells in each of the plurality of pages may be electrically connected to respective bit lines. In some examples, controller 8 may write data to and read data from NAND flash memory devices at the page level and erase data from NAND flash memory devices at the block level. Additional details of memory devices 16 are discussed below with reference to FIG. 2.

FIG. 2 is a conceptual block diagram illustrating an example memory device 16Aa that includes a plurality of blocks 17A-17N (collectively, “blocks 17”), each block including a plurality of pages 19Aa-19Nm (collectively, “pages 19”). Each block of blocks 17 may include a plurality of NAND cells. Rows of NAND cells may be serially electrically connected using a word line to define a page (one page of pages 19). Respective cells in each of a plurality of pages 19 may be electrically connected to respective bit lines. Controller 8 may write data to and read data from NAND flash memory devices at the page level and erase data from NAND flash memory devices at the block level. A group of two or more blocks may be referred to a logical block address collection. For example, logical block address collection 20A may include blocks 17A-17B and logical block address collection 20B may include blocks 17M-17N.

The example of FIG. 2 describes a three-dimensional (3D) flash memory. However, techniques of the current disclosure may be applied to other arrangements of memory, such as next generation memory devices, such as those with no block or page structure. As such, the techniques described herein may also apply to virtual blocks or other arrangements of memory.

Returning to FIG. 1, in some examples, it may not be practical for controller 8 to be separately connected to each memory device of memory devices 16. As such, the connections between memory devices 16 and controller 8 may be multiplexed. As an example, memory devices 16 may be grouped into channels 18A-18N (collectively, “channels 18”). For instance, as illustrated in FIG. 1, memory devices 16Aa-16An may be grouped into first channel 18A, and memory devices 16Na-16Nn may be grouped into N^{th} channel 18N. The memory devices 16 grouped into each of channels 18 may share one or more connections to controller 8. For instance, the memory devices 16 grouped into first channel 18A may be attached to a common I/O bus and a common control bus. Storage device 6 may include a common I/O bus and a common control bus for each respective channel of channels 18. In some examples, each channel of channels 18 may include a set of chip enable (CE) lines which may be used to multiplex memory devices on each channel. For example, each CE line may be connected to a respective memory device of memory devices 18. In this way, the number of separate connections between controller 8 and memory devices 18 may be reduced. Additionally, as each channel has an independent set of connections to controller 8, the reduction in connections may not significantly affect the data throughput rate as controller 8 may simultaneously issue different commands to each channel.

Storage device 6 may include power supply 11, which may provide power to one or more components of storage device 6. When operating in a standard mode, power supply 11 may provide power to the one or more components using power provided by an external device, such as host device 4. For instance, power supply 11 may provide power to the one or more components using power received from host device 4 via interface 14. In some examples, power supply 11 may include one or more power storage components configured to provide power to the one or more components when operating in a shutdown mode, such as where power ceases to be received from the external device. In this way, power supply 11 may function as an onboard backup power source. Some examples of the one or more power storage components include, but are not limited to, capacitors, super capacitors, batteries, and the like.

Storage device 6 also may include volatile memory 12, which may be used by controller 8 to store information. In some examples, controller 8 may use volatile memory 12 as a cache. For instance, controller 8 may store cached information in volatile memory 12 until the cached information is written to memory devices 16. Volatile memory 12 may consume power received from power supply 11. Examples of volatile memory 12 include, but are not limited to, random-access memory (RAM), dynamic random access memory (DRAM), static RAM (SRAM), and synchronous dynamic RAM (SDRAM—e.g., double data rate (DDR) 1, DDR2, DDR3, DDR3L, low power DDR (LPDDR) 3, DDR4, and the like).

Host device 4 may access storage device 6 through or more virtual machines 13 (hereinafter, “virtual machine 13”). Virtual machine 13 may be an emulation of a computer system. Virtual machine 13 may be based on computer architectures and provide functionality similar to that of a physical computer. In implementation, virtual machine 13 may involve specialized hardware, software, or a combination. Controller 8 may assign host device 4 to virtual machine 13 such that host device 4 may access NVMA 10 or some portion thereof. With this access, virtual machine 13 may provide an interface between host device 4 and NVMA 10 such that host device 4 may interact with NVMA 10 to retrieve data stored to NVMA 10 or write data to NVMA 10.

Storage device 6 includes controller 8, which may manage one or more operations of storage device 6. For example, controller 8 may manage the reading of data from and/or the writing of data to memory devices 16. Controller 8 may interface with host device 4 via interface 14 and manage the storage of data to and the retrieval of data from non-volatile memory 12 and memory devices 16. Controller 8 may, as one example, manage writes to and reads from memory devices 16 and non-volatile memory 12. In some examples, controller 8 may be a hardware controller. In other examples, controller 8 may be implemented into data storage device 6 as a software controller.

Controller 8 may provide an execution environment for virtual machine 13. Although shown in the example of FIG. 1 as executing or otherwise including virtual machine 13, virtual machine 13 may represent software or other computer executable instructions that configures host 4 to provide a virtual representation of a machine. In effect, virtual machine 13 represents a time-based partitioning of host 4 (e.g., in terms of processor cycles, registers, caches, etc.) that are reserved for use in presenting virtual machine 13 to controller 8. Virtual machine 13 may, in this respect, represent a computer executable stored to host 4 or other memory that host 4 may retrieve and execute to present a virtual machine workload to controller 8.

In accordance with techniques of this disclosure, controller 8 may determine a maximum amount of storage access for virtual machine 13 in NVMA 10 when each cell in the storage access is configured in a first level mode. When each cell in the storage access is configured in the first level mode, each cell in the storage access may have a maximum allowable number of bits per cell. The storage access may be any portion of memory devices 16, or the entirety of NVMA 10.

For instance, in the example of FIG. 1, the storage access for virtual machine 13 may include the entirety of NVMA 10 (i.e., all of the cells in each of pages 19 shown in FIG. 2). NVMA 10 may include X number of cells, each of which has a maximum capacity of three bits per cell (i.e., when the cells are in TLC mode). As such, the maximum amount of storage access for virtual machine 13 may be 3X total bits.

Controller 8 may configure each cell in the storage access for virtual machine 13 to be in a second level mode. When each cell in the storage access is configured in the second level mode, each cell in the storage access may have a number of bits per cell less than the maximum allowable number of bits per cell. For instance, controller 8 may configure each of the 128 cells in NVMA 10 to be in SLC mode, such that each of the 128 cells are configured to only store a single bit per cell, rather than the maximum allowable number of bits per cell when the cells are configured in TLC mode. As such, NVMA 10 may only be configured to store X of the maximum 3X bits upon configuration. In some instances, host device 4 may be unaware of the lower capacity (i.e., X bits). As such, host device 4 may only be aware of the true maximum capacity (i.e., 3X bits).

At some point, such as during garbage collection or after controller 8 performs a certain number of write operations to NVMA 10, controller 8 may determine a total number of bits in use in each cell of the storage access and compare the total number of bits in use in each cell of the storage access to a threshold number of bits in use in each cell of the storage access. In some instances, the threshold number of bits may be some percentage of the maximum capacity given the current mode, such as 75%, 80%, or 100%, among other percentages.

Based on the comparison, controller 8 may reconfigure one or more of the cells in the storage access for virtual machine 13 to be in a third level mode. When the one or more of the cells in the storage access are configured in the third level mode, each cell in the storage access may have a number of bits per cell greater than the number of bits per cell for the second level mode. For instance, controller 8 may determine that the total number of bits in use across each cell (currently all in SLC mode) of NVMA 10 is equal to 0.95X bits. The 0.95X-bit total may exceed the threshold number of bits for NVMA 10.

Based on this comparison, controller 8 may reconfigure one or more of the cells in the storage access to be in MLC mode, such that the one or more of the cells may store two bits per cell rather than one bit per cell. In some instances, controller 8 may only reconfigure enough cells such that the total number of bits no longer exceeds the threshold number of bits (i.e., such that the total number of bits is less than the designated percentage of the threshold). In other instances, controller 8 may reconfigure the entire storage access to be in the third level mode.

By configuring and reconfiguring the storage access in this way, controller 8 may increase the overall efficiency of data management within storage device 6. When storage device 6 contains less data, controller 8 may operate the storage access in a lower-capacity mode, as speed and efficiency may be more important than the capacity. However, when storage device 6 accumulates more and more data, controller 8 may alter the storage access to allow for a higher capacity while sacrificing as little speed, reliability, and security as necessary.

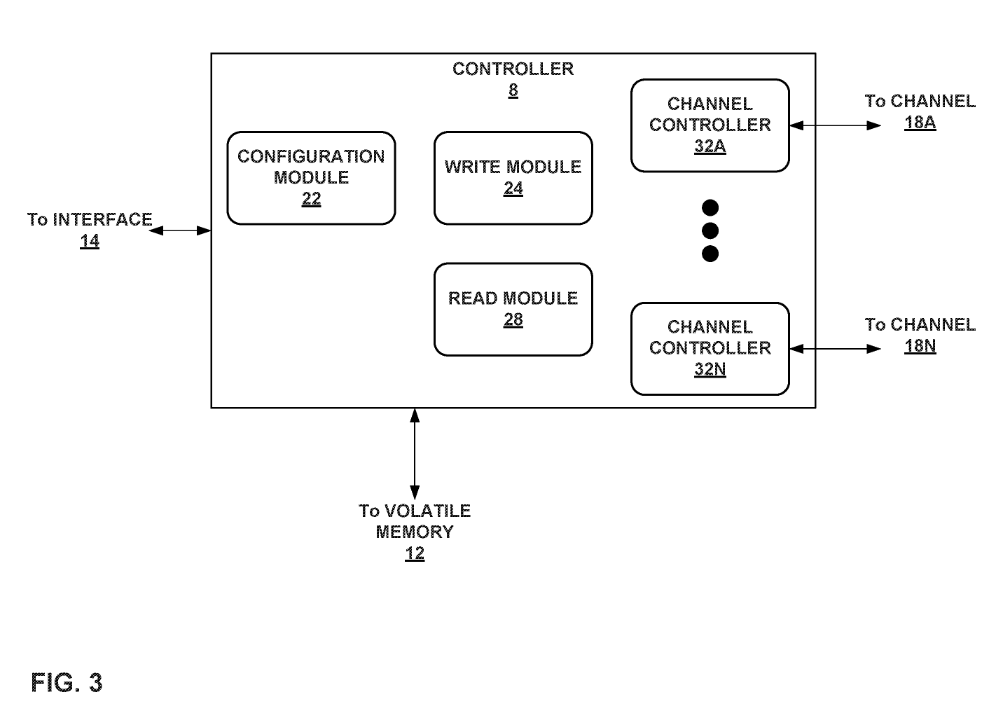

FIG. 3 is a conceptual and schematic block diagram illustrating an example controller 8 configured to perform self-virtualization based on memory usage, in accordance with one or more techniques of this disclosure. In some examples, controller 8 may include virtual machine 13, configuration module 22, write module 24, read module 28, and a plurality of channel controllers 32A-32N (collectively, “channel controllers 32”). In other examples, controller 8 may include additional modules or hardware units, or may include fewer modules or hardware units. Controller 8 may include one or more microprocessors, digital signal processors (DSP), application specific integrated circuits (ASIC), field programmable gate arrays (FPGA), or other digital logic circuitry.

Controller 8 may interface with the host device 4 via interface 14 and manage the storage of data to and the retrieval of data from memory devices 16. For example, write module 24 of controller 8 may manage writes to memory devices 16. For example, write module 24 may receive a message from host device 4 via interface 14 instructing storage device 6 to store data associated with a logical address and the data, which may be referred to as user data. Write module 24 may manage writing of the user data to memory devices 16.

For example, write module 24 may manage translation between logical addresses used by host device 4 to manage storage locations of data and physical block addresses used by write module 24 to direct writing of data to memory devices. Write module 24 of controller 8 may utilize a flash translation layer or indirection table that translates logical addresses (or logical block addresses) of data stored by memory devices 16 to physical block addresses of data stored by memory devices 16. For example, host device 4 may utilize the logical block addresses of the data stored by memory devices 16 in instructions or messages to storage device 6, while write module 24 utilizes physical block addresses of the data to control writing of data to memory devices 16. (Similarly, read module 28 may utilize physical block addresses to control reading of data from memory devices 16.) The physical block addresses correspond to actual, physical blocks of memory devices 16. In some examples, write module 24 may store the flash translation layer or table in volatile memory 12. Upon receiving the one or more physical block addresses, write module 24 may define and/or select one or more physical blocks, and communicate a message to channel controllers 32A-32N (collectively, “channel controllers 32”), which causes the channel controllers 32 to write the data to the physical blocks.

Each channel controller of channel controllers 32 may be connected to a respective channel of channels 18. In some examples, controller 8 may include the same number of channel controllers 32 as the number of channels 18 of storage device 2. Channel controllers 32 may perform the intimate control of addressing, programming, erasing, and reading of memory devices 16 connected to respective channels, e.g., under control of write module 24 and/or read module 28.

In accordance with techniques of this disclosure, configuration module 22 of controller 8 may determine a maximum amount of storage access for virtual machine 13 in NVMA 10 when each cell in the storage access is configured in a first level mode. When each cell in the storage access is configured in the first level mode, each cell in the storage access may have a maximum allowable number of bits per cell. The storage access may be any portion of memory devices 16, or the entirety of NVMA 10.

For instance, in the example of FIG. 3, the storage access for virtual machine 13 may include one third of NVMA 10. The entirety of NVMA 10 may include 3 gigabytes (GB) of total storage when each cell has a maximum capacity of three bits per cell (i.e., when the cells are in TLC mode). As such, the maximum amount of storage access for virtual machine 13 may be 1 GB.

In such instances, virtual machine 13 may include a plurality of different virtual machines, each of which may provide access to a unique storage access within NVMA 10. As such, each virtual machine may be configured to connect a respective host device to a different storage access.

In some examples, NVMA 10 may include a plurality of blocks, each block including a plurality of pages, and each page including a plurality of cells. In such examples, a first portion of each block (e.g., one or more pages of the block or some portion of the cells of a page within the block) may be configured in the first level mode (i.e., TLC mode), a second portion of each block (e.g., one or more pages of the block or some portion of the cells of a page within the block) may be configured in a second level mode (i.e., SLC mode), and a third portion of each block (e.g., one or more pages of the block or some portion of the cells of a page within the block) may be configured in a third level mode (i.e., MLC mode).

In other examples, different combinations of modes, including a quad-level cell (QLC) mode, may be used for the different portions of the blocks (e.g., one or more pages of the block or some portion of the cells of a page within the block). Each block may be partitioned into as few as one portion per block (i.e., each page of the block has a uniform level mode). Each block may also have multiple portions, including two portions, three portions, four portions, or more, with each portion being initially configured to be in a different level mode. Each portion may belong to a different storage access, and each storage access may correspond with a different virtual machine workload for a host device.

Configuration module 22 may configure each cell in the storage access for virtual machine 13 to be in a second level mode. When each cell in the storage access is configured in the second level mode, each cell in the storage access may have a number of bits per cell less than the maximum allowable number of bits per cell. For instance, controller 8 may configure each cell of the 1 GB storage access in NVMA 10 to be in SLC mode, such that each of the cells is configured to only store a single bit per cell, rather than the maximum allowable number of bits per cell when the cells are configured in TLC mode. As such, NVMA 10 may only be configured to store ⅓ GB of the maximum 1 GB upon configuration. In some instances, host device 4 may be unaware of the lower capacity (i.e., ⅓ GB). As such, host device 4 may only be aware of the true maximum capacity (i.e., 1 GB).

As stated above, NVMA 10 may be divided into three storage accesses. Each of the three storage accesses may have the same maximum capacity, evenly dividing NVMA 10 into thirds. Configuration module 22 may initially configure one of the storage accesses to be in the SLC mode, as described above. Configuration module 22 may initially configure a second storage access of NVMA 10 to be in the MLC mode. Configuration module 22 may initially configure a third storage access of NVMA 10 to be in the TLC mode. By utilizing three different level modes for the storage accesses, controller 8 may provide hosts with access to a storage access that best fits their needs. For instance, controller 8 may direct a host that requires high security levels for long-term storage to the storage access configured to be in SLC mode. Conversely, controller 8 may direct a host that needs short-term storage and lower security levels to the storage access configured to be in TLC mode.

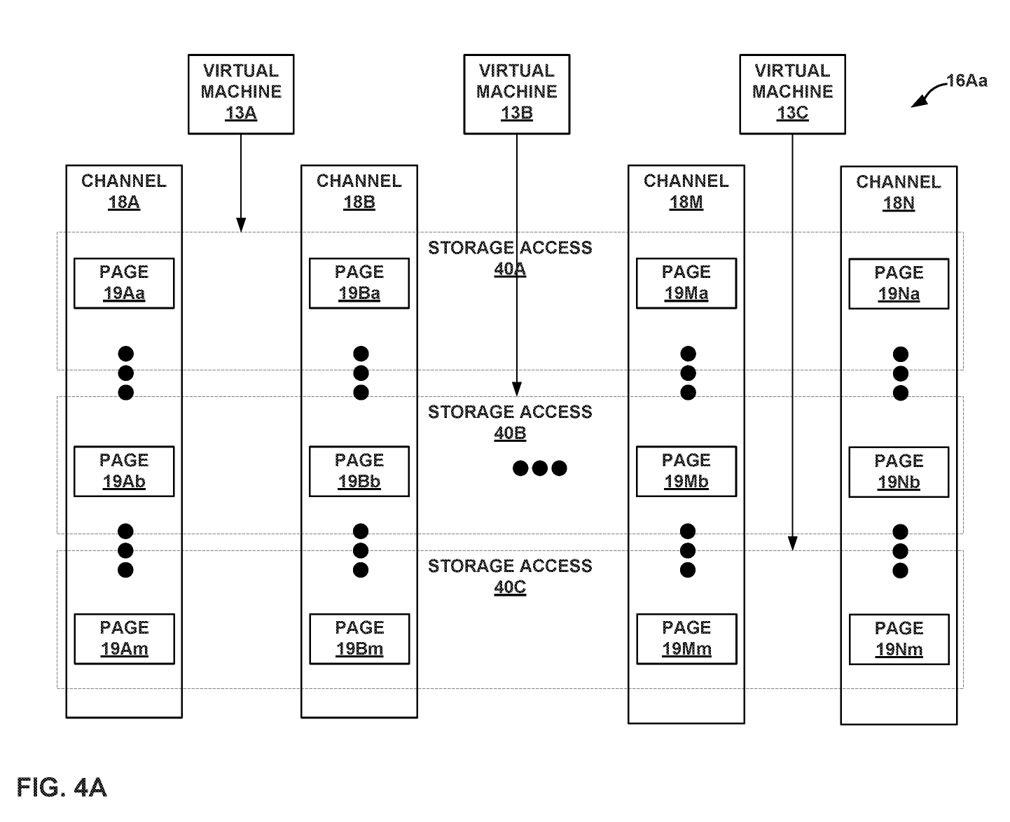

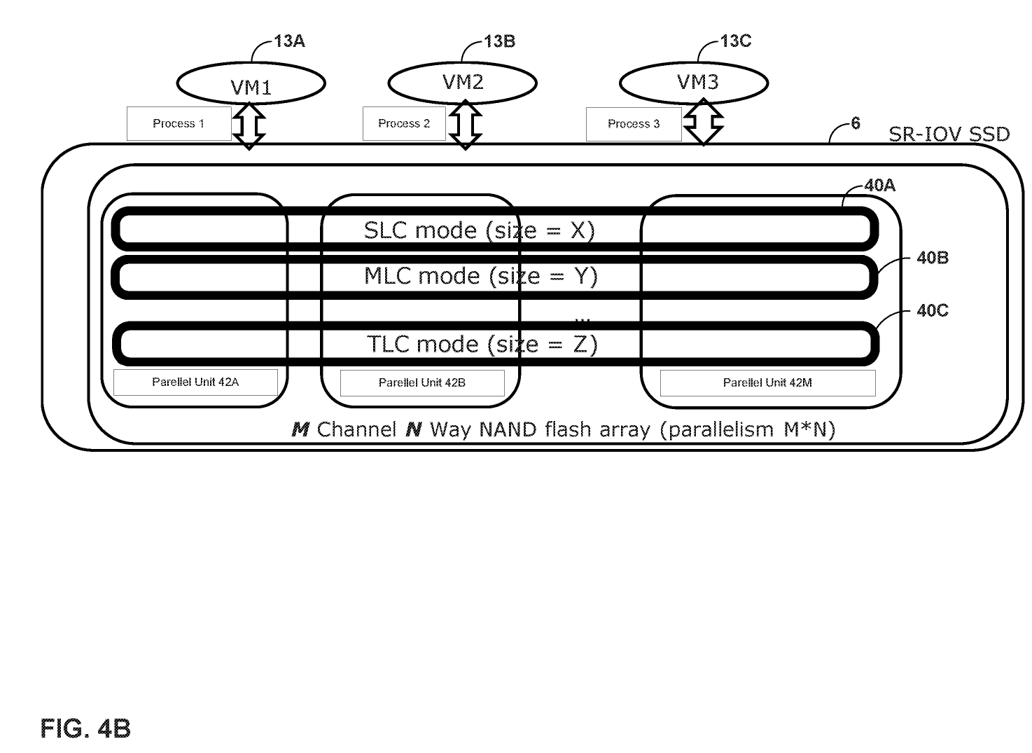

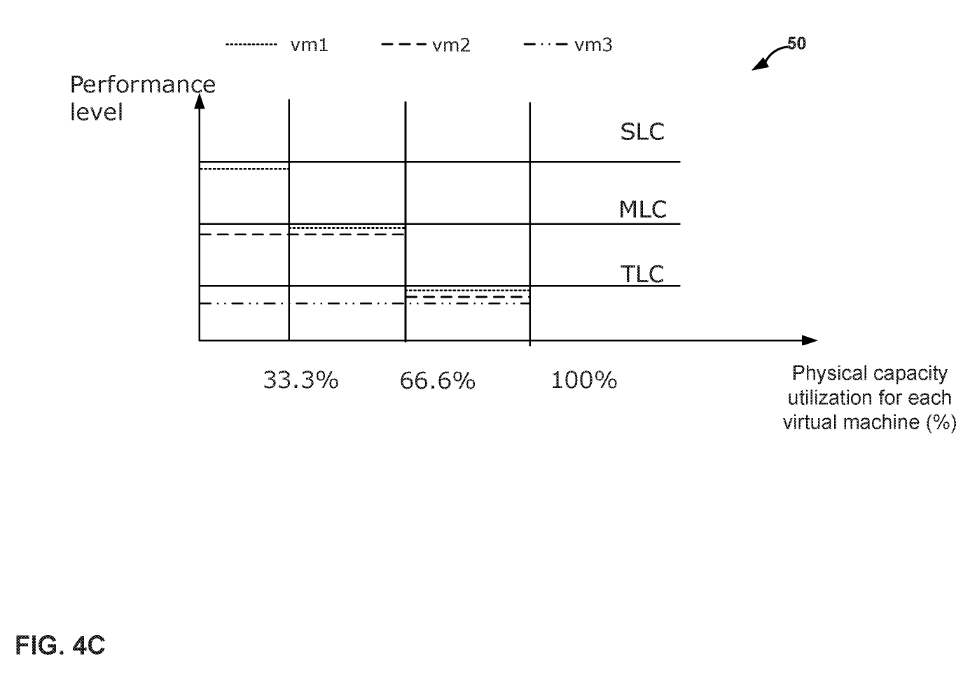

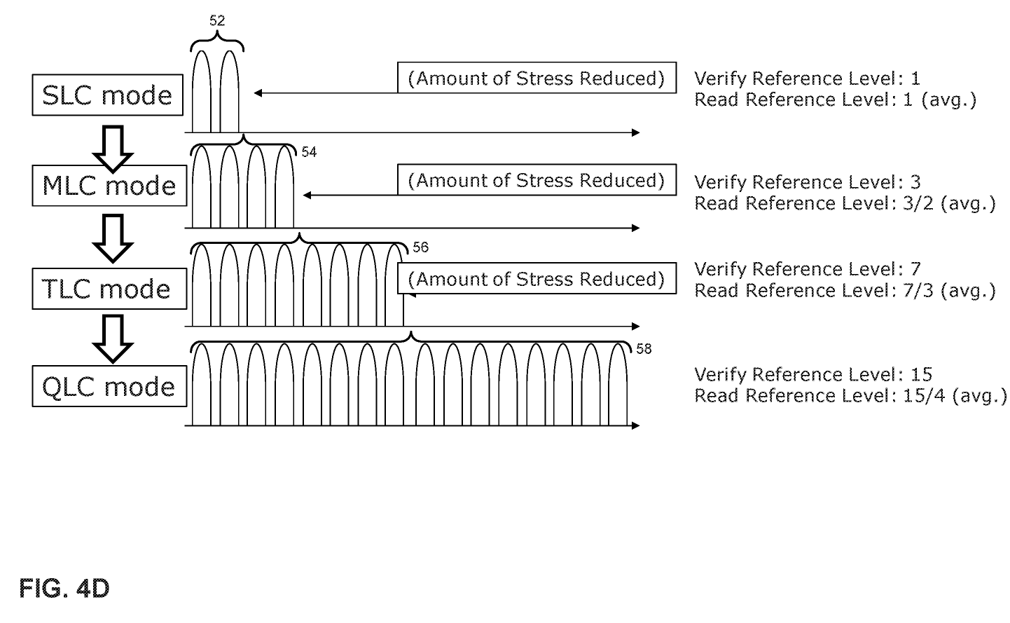

FIG. 4D describes such a configuration. In FIG. 4D, special program and read commands (i.e. NAND flash memory supports) are assumed such that the number of verify and read reference levels can be flexibly changed during the lifetime of the device. Program and read operations when storage device 6 is configured in SLC mode becomes much faster than when storage device 6 is configured in QLC mode, and a QLC NAND can initially operate in SLC mode. Flash cell damage becomes smaller with a decreased level of highly programmed state because less electron tunneling is involved for program and erase cycling. Damage during SLC mode is much smaller than QLC, so initial SLC mode operation would not degrade entire NAND reliability much.

In FIG. 4D, voltage group 52 represents the different configurations of a cell in SLC mode. As only one bit is stored in each cell, the cell may be configured as either a 0 or a 1. As such, only a single charge is needed for each of the verify reference level and the read reference level operations.

Voltage group 54 represents the different configurations of a cell in MLC mode. Since two bits are stored in each cell, the cell may be configured as either 00, 01, 10, or 11. As such, three charges are needed for each verify reference level operation, and an average of 3/2 charges are needed for each read reference level operation, increasing the amount of electron tunneling involved when compared to SLC mode and decreasing the overall stability of the storage drive.

Voltage group 56 represents the different configurations of a cell in TLC mode. Since three bits are stored in each cell, the cell may be configured as either 000, 001, 010, 011, 100, 101, 110, or 111. As such, seven charges are needed for each verify reference level operation, and an average of 7/3 charges are needed for each read reference level operation, increasing the amount of electron tunneling involved when compared to MLC and SLC mode and decreasing the overall stability of the storage drive.

Voltage group 58 represents the different configurations of a cell in QLC mode. Since four bits are stored in each cell, the cell may be configured as either 0000, 0001, 0010, 0011, 0100, 0101, 0110, 0111, 1000, 1001, 1010, 1011, 1100, 1101, 1110, or 1111. As such, fifteen charges are needed for each verify reference level operation, and an average of 15/4 charges are needed for each read reference level operation, increasing the amount of electron tunneling involved when compared to TLC, MLC, and SLC mode and decreasing the overall stability of the storage drive.

In switching between the configurations shown in FIG. 4D, configuration module 22 may alter the voltages that traverse each cell. A single cell may be programmed by injecting charge into a floating gate of the cell to result in one of the voltage states V1-V16 being the cell threshold voltage. Voltage group 52 may only include two of these voltage states. Voltage group 54 may only include four of these voltage states. Voltage group 56 may only include eight of these voltage states. Voltage group 58 may include each of these voltage states. Read module 28 may cause one or more of channel controllers 18 to distinguish between the possible voltages of the v^{th} cell to read data from the cells by applying read reference voltages R1-R15 that fall between two “adjacent” possible cell voltages of V1-V16. As shown in the example shown in FIG. 4D, read module 28 may use the first read reference voltage R1 to distinguish voltage V1 from the remaining voltages V2-V16 for the cell. Similarly, read module 28 may use the second read reference voltage R2 to distinguish between a {V1, V2} selection and a {V3-V16} selection. In other words, read module 28 may use the second reference read voltage to distinguish between a cell with a voltage of V1 or V2 and a cell with a voltage of any of V3-V16. Read module 28 may use a third reference read voltage R3 to distinguish between voltages V4-V16 and the remaining voltages V1-V3, and so on. This further shows how a cell configured in SLC mode endures less stress than a cell configured in QLC mode.

Returning now to FIG. 3, in such examples, configuration module 22 may receive a request from a host device to access NVMA 10. Configuration module 22 may determine a guest level for the host device. The guest level may be based on a security level of the host device, data storage requirements for the host device, or any other information about the host device that may influence the data storage needs for the host device. Based at least in part on the guest level for the host device, controller 8 may assign the host device to a particular virtual machine workload such that the host device is assigned to the virtual machine workload that most closely matches the needs of the virtual machine of host device.

At some point, such as during garbage collection or after write module 24 performs a certain number of write operations to the storage access in NVMA 10, configuration module 22 may determine a total number of bits in use in each cell of the storage access and compare the total number of bits in use in each cell of the storage access to a threshold number of bits in use in each cell of the storage access. In some instances, the threshold number of bits may be some percentage of the maximum capacity given the current mode, such as 75%, 80%, or 100%, among other percentages.

Based on the comparison, configuration module 22 may reconfigure one or more of the cells in the storage access for virtual machine 13 to be in a third level mode. When the one or more of the cells in the storage access are configured in the third level mode, the one or more cells in the storage access may have a number of bits per cell greater than the number of bits per cell for the second level mode. For instance, controller 8 may determine that the total number of bits in use across each cell (currently all in SLC mode) of the storage access is equal to 95% of the usable bits. The 95% bit usage may exceed the threshold number of bits for the storage access.

Based on this comparison, configuration module 22 may reconfigure one or more of the cells in the storage access to be in MLC mode, such that the one or more of the cells may store two bits per cell rather than one bit per cell. In some instances, controller 8 may only reconfigure enough pages of cells such that the total number of bits no longer exceeds the threshold number of bits (i.e., such that the total number of bits is less than the designated percentage of the threshold). In other instances, configuration module 22 may determine a number of pages of cells required to be in the third level mode in order for write module 24 to be able to write the entirety of the received data request to the storage access. In still other instances, controller 8 may reconfigure the entire storage access to be in the third level mode. In the example of FIG. 2, configuration module 22 may reconfigure the entirety of the storage access to be in MLC mode. As such, the new storage capacity for the storage access may be ⅔ GB.

In some instances, at a later time, such as during garbage collection, SR/IOV, or after write module 24 performs a certain number of write operations to the storage access in NVMA 10, configuration module 22 may again compare the total number of bits in use in each cell of the storage access to a second threshold number of bits in use in each cell of the storage access configured in the third level mode (i.e., the MLC mode). If the total number of bits in use exceeds the second threshold, configuration module 22 may reconfigure one or more of the cells in the storage access to be in the first level mode (i.e., the TLC mode). In doing so, configuration module 22 would increase the capacity of the storage access to be the full 1 GB maximum capacity. As such, controller 8 may utilize more secure and efficient modes of data storage in the storage access until it is necessary to decrease the speed of the storage access due to the need for an increased capacity.

Throughout the above example, reference was made to NVMA 10 being configured to be partitioned into three storage accesses and to utilize three different level modes. In some instances, NVMA 10 may only be configured to be partitioned into two storage accesses and/or only utilize two level modes. In such instances, configuration module 22 may configure the cells within the two storage accesses to vary between a first level mode (e.g., SLC mode) and a second level mode (MLC mode)

In other instances, NVMA 10 may be partitioned into four storage accesses and/or utilize four different level modes. For example, NVMA 10 may have a maximum storage capacity of 4 GB, with each storage access covering 1 GB. In such instances, the first level mode may be a quad-level cell (QLC) mode where the maximum allowable number of bits per cell for the QLC mode is equal to four bits per cell. Configuration module 22 may initially configure the cells in the storage access to be in the SLC mode, meaning the storage access may have a capacity of ¼ GB.

Similarly, to the process outlined above, configuration module 22 may reconfigure the storage access to be in MLC mode when the total number of bits in use in each of the cells of the storage access exceeds a first threshold number, increasing the capacity of the storage access to ½ GB. In some instances, at a later time, such as during garbage collection, SR/IOV, or after write module 24 performs a certain number of write operations to the storage access in NVMA 10, configuration module 22 may again compare the total number of bits in use in each cell of the storage access to a second threshold number of bits in use in each cell of the storage access configured in the third level mode (i.e., the MLC mode). If the total number of bits in use exceeds the second threshold, configuration module 22 may reconfigure one or more of the cells in the storage access to be in a fourth level mode, such as the TLC mode. In doing so, configuration module 22 would increase the capacity of the storage access to be ¾ GB.

Again, at an even later time, such as during garbage collection, SR/IOV, or after write module 24 performs a certain number of write operations to the storage access in NVMA 10, configuration module 22 may again compare the total number of bits in use in each cell of the storage access to a third threshold number of bits in use in each cell of the storage access configured in the fourth level mode (i.e., the TLC mode). If the total number of bits in use exceeds the third threshold, configuration module 22 may reconfigure one or more of the cells in the storage access to be in the first level mode (i.e., the QLC mode). In doing so, configuration module 22 would increase the capacity of the storage access to be the maximum capacity of 1 GB.

FIG. 4A is a conceptual and schematic block diagram illustrating example details of a memory device 16Aa containing data blocks grouped by a controller into storage accesses 40A-40C for the self-virtualization process, in accordance with one or more techniques of this disclosure. For ease of illustration, the exemplary technique of FIG. 4 will be described with concurrent reference to data blocks 17A-17N (herein after “data blocks 17”) of memory device 16Aa and controller 8 of FIGS. 1, 2, and 3. However, the techniques may be used with any combination of hardware or software.

In the example of FIG. 4A, the data storage portion of memory device 16Aa includes a plurality of blocks 17A-17N. Each of blocks 17A-17N further includes a plurality of pages 19. Each of pages 19 includes a plurality of cells. Memory device 16Aa further includes three storage accesses 40A-40C. Each storage access of storage accesses 40A-40C includes a portion of each of blocks 17A-17N. In some examples, each of storage accesses 40A-40C may include one third of each of blocks 17A-17N. In other examples, each of storage accesses 40A-40C may include unequal percentages of each of blocks 17A-17N, where the percentage is based on typical needs of host devices accessing the respective storage access 40A-40C.

Virtual machines 13A-13C may include the functionality of virtual machine 13 described above with respect to FIGS. 1 and 3. In the example of FIG. 4, virtual machine 13A may provide a host device with access to storage access 40A. Similarly, virtual machine 13B may provide a host device with access to storage access 40B. Finally, virtual machine 13C may provide a host device with access to storage access 40C.

In accordance with the techniques described herein, controller 8 may initially configure each of storage accesses 40A-40C to be in a different level mode. For instance, controller 8 may initially configure the cells of pages 19Aa-19Na in storage access 40A to be in SLC mode, where each cell in pages 19Aa-19Na is configured to only store one bit per cell. As such, storage access 40A may only be configured to initially store one third of the maximum possible amount of bits. Similarly, controller 8 may initially configure the cells of pages 19Ab-19Nb in storage access 40B to be in MLC mode, where each cell in pages 19Ab-19Nb is configured to store two bits per cell. As such, storage access 40B may only be configured to initially store two thirds of the maximum possible amount of bits. Finally, controller 8 may initially configure the cells of pages 19Am-19Nm in storage access 40C to be in TLC mode, where each cell in pages 19Am-19Nm is configured to only store the maximum three bits per cell. As such, storage access 40C may only be configured to initially store one third of the maximum possible amount of bits.

During garbage collection or SR-IOV, controller 8 may determine a number of bits being used in storage access 40A. If controller 8 determines that the number of bits exceeds a threshold number of bits, controller 8 may reconfigure one or more of the cells in pages 19Aa-19Na of storage access 40A to be in MLC mode rather than SLC mode. Similarly, if controller 8 determines that the number of bits being used in storage access 40B exceeds a second threshold (or that the number of bits being used in storage access 40A exceeds the second threshold after storage access 40A is converted to the MLC mode), controller 8 may reconfigure one or more of the cells in pages 19Ab-19Nb in storage access 40B (or one or more of the cells in pages 19Aa-19Na in storage access 40A) to be in TLC mode. As such, controller 8 may utilize more secure and efficient modes of data storage in storage accesses 40A-40C until it is necessary to decrease the security of the storage access due to the need for an increased capacity.

FIG. 4B is another conceptual and schematic block diagram illustrating example details of a memory device containing data blocks grouped by a controller into storage accesses for the self-virtualization process, in accordance with one or more techniques of this disclosure. The total SSD 6 capacity is equal to X+Y+Z. X is the capacity for virtual machine (“VM”) 1 13A, Y is the capacity for VM2 13B, and Z is the capacity for VM3 13C. The priority for these virtual machines is VM1 13A, then VM2 13B, then VM3 13C. VM1 may be utilized for a first type of processes, VM2 may be utilized for a second type of processes, and VM3 may be utilized for a third type of processes.

FIG. 4C is a diagram 50 outlining performance level and physical capacity utilization for each virtual machine workload for various level cell modes in accordance with one or more techniques of this disclosure. In diagram 50, the SSD may have three storage accesses, each of which are accessible using a different respective virtual machine workload. As shown in diagram 50, the performance level is highest for a cell in a storage access configured in SLC mode (accessed using the virtual machine workload of VM1), although the physical capacity utilization percentage is the smallest. The performance level is next highest for a cell in a storage access configured in MLC mode (accessed using the virtual machine workload of VM2 or the virtual machine workload of VM1 once the storage capacity is too high for the respective storage access to be in SLC mode), and the physical capacity utilization percentage is two-thirds of the maximum capacity. The performance level is lowest for a cell in a storage access configured in TLC mode (accessed using the virtual machine workload of VM3 or the virtual machine workload of VM1 or VM2 once the storage capacity is too high for the respective storage access to be in MLC mode), though the physical capacity utilization percentage of the storage access is highest.

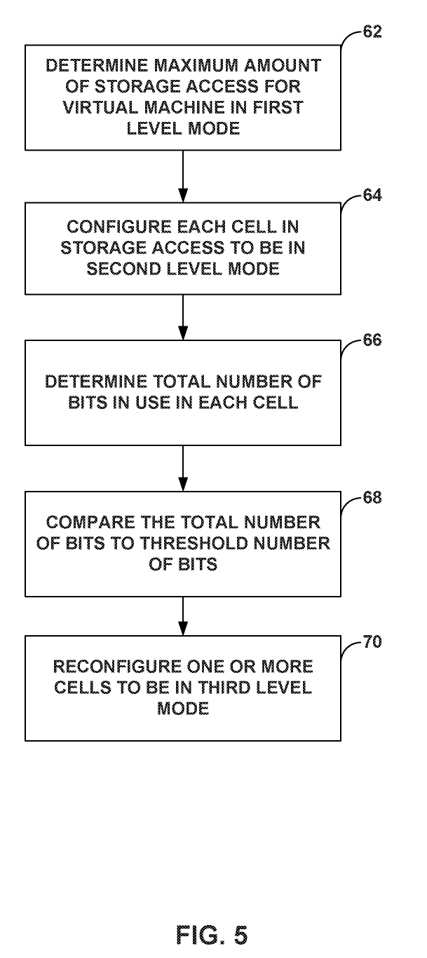

FIG. 5 is a flow diagram illustrating example self-virtualization operations performed by a controller of a storage device, in accordance with one or more techniques of this disclosure. For ease of illustration, the exemplary technique of FIG. 5 will be described with concurrent reference to storage device 6 and controller 8 of FIGS. 1 and 3. However, the techniques may be used with any combination of hardware or software.

In accordance with techniques of this disclosure, controller 8 may determine a maximum amount of storage access for virtual machine 13 in NVMA 10 when each cell in the storage access is configured in a first level mode (62). When each cell in the storage access is configured in the first level mode, each cell in the storage access may have a maximum allowable number of bits per cell. The storage access may be any portion of memory devices 16, or the entirety of NVMA 10.

For instance, in the example of FIG. 1, the storage access for virtual machine 13 may include the entirety of NVMA 10 (i.e., each of the cells in pages 19). NVMA 10 may include 256 total cells, each of which has a maximum capacity of three bits per cell (i.e., when the cells are in TLC mode). As such, the maximum amount of storage access for virtual machine 13 may be 768 total bits.

Controller 8 may configure each cell in the storage access for virtual machine 13 to be in a second level mode (64). When each cell in the storage access is configured in the second level mode, each cell in the storage access may have a number of bits per cell less than the maximum allowable number of bits per cell. For instance, controller 8 may configure each of the 256 cells in NVMA 10 to be in SLC mode, such that each of the 256 cells is configured to only store a single bit per cell, rather than the maximum allowable number of bits per cell when the cells are configured in TLC mode. As such, NVMA 10 may only be configured to store 256 of the maximum 768 bits upon configuration. In some instances, host device 4 may be unaware of the lower capacity (i.e., 256 bits). As such, host device 4 may only be aware of the true maximum capacity (i.e., 768 bits).

At some point, such as during garbage collection or after controller 8 performs a certain number of write operations to NVMA 10, controller 8 may determine a total number of bits in use in each cell of the storage access (66) and compare the total number of bits in use in each cell of the storage access to a threshold number of bits in use in each cell of the storage access (68). In some instances, the threshold number of bits may be some percentage of the maximum capacity given the current mode, such as 75%, 80%, or 100%, among other percentages.

Based on the comparison, controller 8 may reconfigure one or more of cells 19 in the storage access for virtual machine 13 to be in a third level mode (70). When the one or more of the cells in the storage access are configured in the third level mode, each of the one or more of the cells in the storage access may have a number of bits per cell greater than the number of bits per cell for the second level mode. For instance, controller 8 may determine that the total number of bits in use across each cell (currently all in SLC mode) of NVMA 10 is equal to 254 bits. The 254-bit total may exceed the threshold number of bits for NVMA 10.

Based on this comparison, controller 8 may reconfigure one or more of the cells in the storage access to be in MLC mode, such that the one or more of the cells may store two bits per cell rather than one bit per cell. In some instances, controller 8 may only reconfigure enough cells such that the total number of bits no longer exceeds the threshold number of bits (i.e., such that the total number of bits is less than the designated percentage of the threshold). In other instances, controller 8 may reconfigure the entire storage access to be in the third level mode.

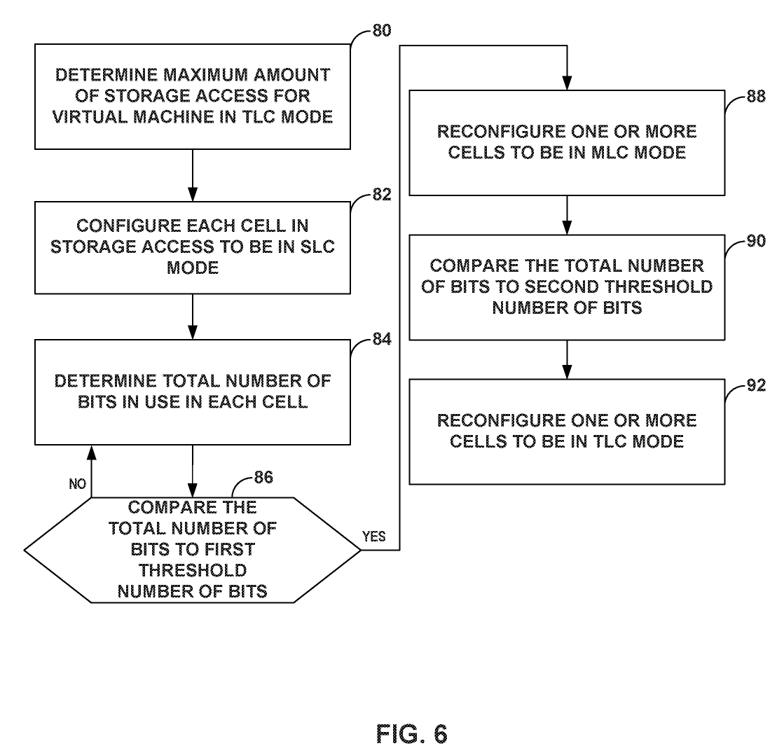

FIG. 6 is a flow diagram illustrating more detailed example self-virtualization operations performed by a controller of a storage device, in accordance with one or more techniques of this disclosure. For ease of illustration, the exemplary technique of FIG. 6 will be described with concurrent reference to storage device 6 and controller 8 of FIGS. 1 and 3. However, the techniques may be used with any combination of hardware or software.

In accordance with techniques of this disclosure, controller 8 may determine a maximum amount of storage access for virtual machine 13 in NVMA 10 when each cell in the storage access is configured in TLC mode (80). For instance, in the example of FIG. 1, the storage access for virtual machine 13 may include one third of NVMA 10. The entirety of NVMA 10 may include 3 gigabytes (GB) of total storage when each cell has a maximum capacity of three bits per cell (i.e., when the cells are in TLC mode). As such, the maximum amount of storage access for virtual machine 13 may be 1 GB.

Controller 8 may configure each cell in the storage access for virtual machine 13 to be in SLC mode (82). As such, each of the cells is configured to only store a single bit per cell, rather than the maximum allowable number of bits per cell when the cells are configured in TLC mode. In other words, NVMA 10 may only be configured to store ⅓ GB of the maximum 1 GB upon configuration. In some instances, host device 4 may be unaware of the lower capacity (i.e., ⅓ GB). As such, host device 4 may only be aware of the true maximum capacity (i.e., 1 GB).

At some point, such as during garbage collection or after write module 24 performs a certain number of write operations to the storage access in NVMA 10, configuration module 22 may determine a total number of bits in use in each cell of the storage access (84) and compare the total number of bits in use in each cell of the storage access to a threshold number of bits in use in each cell of the storage access (86). In some instances, the threshold number of bits may be some percentage of the maximum capacity given the current mode, such as 75%, 80%, or 100%, among other percentages.

Based on the comparison, configuration module 22 may reconfigure one or more of the cells in the storage access for virtual machine 13 to be in MLC mode (88). For instance, controller 8 may determine that the total number of bits in use across each cell (currently all in SLC mode) of NVMA 10 is equal to 95% of the usable bits. The 95% bit usage may exceed the threshold number of bits for NVMA 10. Based on this comparison, configuration module 22 may reconfigure one or more of the cells in the storage access to be in MLC mode, such that the one or more of the cells may store two bits per cell rather than one bit per cell. In some instances, controller 8 may only reconfigure enough cells such that the total number of bits no longer exceeds the threshold number of bits (i.e., such that the total number of bits is less than the designated percentage of the threshold). In other instances, configuration module 22 may determine a number of cells required to be in the third level mode in order for write module 24 to be able to write the entirety of the received data request to the storage access. In other instances, controller 8 may reconfigure the entire storage access to be in the third level mode. In the example of FIG. 6, configuration module 22 may reconfigure the entirety of the storage access to be in MLC mode. As such, the new storage capacity for the storage access may be ⅔ GB.

In some instances, at a later time, such as during garbage collection, SR/IOV, or after write module 24 performs a certain number of write operations to the storage access in NVMA 10, configuration module 22 may again compare the total number of bits in use in each cell of the storage access to a second threshold number of bits in use in each cell of the storage access configured in the third level mode (i.e., the MLC mode) (90). If the total number of bits in use exceeds the second threshold, configuration module 22 may reconfigure one or more of the cells in the storage access to be in the TLC mode (92). In doing so, configuration module 22 would increase the capacity of the storage access to be the full 1 GB maximum capacity. As such, controller 8 may utilize more secure and efficient modes of data storage in the storage access until it is necessary to decrease the security of the storage access due to the need for an increased capacity.

### Example 1

A method comprising: determining, by a controller, a maximum amount of storage access for a virtual machine workload on a solid state drive (SSD) when each cell in the storage access is configured in a first level mode, wherein each of the cells in the storage access being configured in the first level mode comprises each of the cells in the storage access having a maximum allowable number of bits per cell; configuring, by the controller, each of the cells in the storage access for the virtual machine to be in a second level mode, wherein each of the cells in the storage access being configured in the second level mode comprises each of the cells in the storage access having a number of bits per cell less than the maximum allowable number of bits per cell; determining, by the controller, a total number of bits in use in each of the cells of the storage access; comparing, by the controller, the total number of bits in use in each of the cells of the storage access to a threshold number of bits in use in each of the cells of the storage access; and based on the comparison, reconfiguring, by the controller, one or more of the cells in the storage access for the virtual machine to be in a third level mode, wherein the one or more cells in the storage access being configured in the third level mode comprises each of the cells in the storage access having a number of bits per cell greater than the number of bits per cell for the second level mode.

### Example 2

The method of example 1, wherein the first level mode comprises a triple-level cell (TLC) mode, wherein the maximum allowable number of bits per cell is equal to three bits per cell, wherein the second level mode comprises a single-level cell (SLC) mode, wherein the number of bits per cell for the SLC mode is one bit per cell, wherein the third level mode comprises a multiple-level cell (MLC) mode, wherein the number of bits per cell for the MLC mode is two bits per cell, wherein the storage access comprises a first storage access, wherein configuring each of the cells in the first storage access to be in the second level mode comprises initially configuring each of the cells in the first storage access to be in the SLC mode, and wherein the method further comprises: initially configuring, by the controller, a second storage access of the SSD to be in the MLC mode, wherein the second storage access is associated with a second virtual machine workload; and initially configuring, by the controller, a third storage access of the SSD to be in the TLC mode, wherein the third storage access is associated with a third virtual machine workload, wherein reconfiguring the first storage access comprises: responsive to determining that the number of bits in use in each of the cells in the first storage access exceeds the threshold number of bits, reconfiguring, by the controller, each of the cells in the first storage access to be in the MLC mode.

### Example 3

The method of any of examples 1-2, wherein the first level mode comprises a triple-level cell (TLC) mode, wherein the maximum allowable number of bits per cell is equal to three bits per cell, wherein the second level mode comprises a single-level cell (SLC) mode, wherein the number of bits per cell for the SLC mode is one bit per cell, wherein the third level mode comprises a multiple-level cell (MLC) mode, and wherein the number of bits per cell for the MLC mode is two bits per cell.

### Example 4

The method of example 3, wherein the threshold number of bits in use comprises a first threshold number of bits, the method further comprising: comparing, by the controller, the total number of bits in use in each of the cells of the storage access to a second threshold number of bits in use in each of the cells of the storage access; and based on the comparison, reconfiguring, by the controller, one or more cells in the storage access for the virtual machine to be in the first level mode, wherein the one or more cells in the storage access being configured in the first level mode comprises each of the cells in the storage access having the maximum allowable number of bits per cell.

### Example 5

The method of any of examples 1-4, wherein the virtual machine comprises a first virtual machine, the method further comprising: determining, by the controller, a maximum amount of storage access for a second virtual machine on the SSD when each of the cells in the storage access is configured in the first level mode; and configuring, by the controller, each of the cells in the storage access for the second virtual machine to be in the third level mode.

### Example 6

The method of example 5, further comprising: receiving, by the controller, a request from a host device to access the SSD; determining, by the controller, a guest level for the host device; and assigning, by the controller, the host device to one of the first virtual machine or the second virtual machine based at least in part on the guest level for the host device.

### Example 7

The method of any of examples 1-6, wherein reconfiguring the one or more cells comprises: receiving, by the controller, a request to write data to the storage access; determining, by the controller, a number of cells required to be in the third level mode in order for the controller to write the received data to the storage access; and reconfiguring, by the controller, the determined number of cells in the storage access to be in the third level mode.

### Example 8

The method of any of examples 1-7, wherein reconfiguring the one or more cells comprises: reconfiguring, by the controller, the entirety of the storage access to be in the third level mode.

### Example 9

The method of any of examples 1-8, wherein the first level mode comprises a quad-level cell (QLC) mode, wherein the maximum allowable number of bits per cell for the QLC mode is equal to four bits per cell, wherein the second level mode comprises a single-level cell (SLC) mode, wherein the number of bits per cell for the SLC mode is one bit per cell, wherein the third level mode comprises a multiple-level cell (MLC) mode, wherein the number of bits per cell for the MLC mode is two bits per cell, wherein the threshold number of bits in use comprises a first threshold number of bits, and wherein the method further comprises: comparing, by the controller, the total number of bits in use in each of the cells of the storage access to a second threshold number of bits in use in each of the cells of the storage access; and based on the comparison, reconfiguring, by the controller, one or more cells in the storage access for the virtual machine to be in a fourth level mode, wherein the one or more cells in the storage access being configured in the fourth level mode comprises each of the cells in the storage access having a number of bits per cell greater than the number of bits per cell for the third level mode.

### Example 10

The method of example 9, wherein the fourth level mode comprises a triple-level cell (TLC) mode, wherein the number of bits per cell for the TLC mode is three bits per cell, and wherein the method further comprises: comparing, by the controller, the total number of bits in use in each of the cells of the storage access to a third threshold number of bits in use in each of the cells of the storage access; and based on the comparison, reconfiguring, by the controller, one or more cells in the storage access for the virtual machine to be in the first level mode, wherein the one or more cells in the storage access being configured in the first level mode comprises each of the cells in the storage access having the maximum allowable number of bits per cell.

### Example 11

The method of any of examples 1-10, wherein reconfiguring the one or more cells comprises: reconfiguring, by the controller, the one or more cells during a garbage collection process.

### Example 12

The method of any of examples 1-11, wherein the storage access comprises a first storage access, wherein the SSD comprises a plurality of blocks, wherein the method further comprises: initially configuring, by the controller, the first storage access comprising a first portion of each block of the plurality of blocks to be in the first level mode, wherein the first storage access is associated with a first virtual machine workload; initially configuring, by the controller, a second storage access comprising a second portion of each block of the plurality of blocks to be in the second level mode, wherein the second storage access is associated with a second virtual machine workload; and initially configuring, by the controller, a third storage access comprising a third portion of each block of the plurality of blocks to be in the third level mode, wherein the third storage access is associated with a third virtual machine workload.

### Example 13

The method of any of examples 1-12, wherein reconfiguring the one or more cells comprises: reconfiguring, by the controller, the one or more cells as part of a single root input/output virtualization process.

### Example 14

A storage device comprising: a storage access comprising a plurality of cells; and a controller configured to: determine a maximum amount of storage access for a virtual machine workload when each of the cells in the storage access is configured in a first level mode, wherein each of the cells in the storage access being configured in the first level mode comprises each of the cells in the storage access having a maximum allowable number of bits per cell; configure each of the cells in the storage access for the virtual machine to be in a second level mode, wherein each of the cells in the storage access being configured in the second level mode comprises each of the cells in the storage access having a number of bits per cell less than the maximum allowable number of bits per cell; determine a total number of bits in use in each of the cells of the storage access; compare the total number of bits in use in each of the cells of the storage access to a threshold number of bits in use in each of the cells of the storage access; and based on the comparison, reconfigure one or more cells in the storage access for the virtual machine to be in a third level mode, wherein the one or more cells in the storage access being configured in the third level mode comprises each of the cells in the storage access having a number of bits per cell greater than the number of bits per cell for the second level mode.

### Example 15

The storage device of example 14, wherein the first level mode comprises a triple-level cell (TLC) mode, wherein the maximum allowable number of bits per cell is equal to three bits per cell, wherein the second level mode comprises a single-level cell (SLC) mode, wherein the number of bits per cell for the SLC mode is one bit per cell, wherein the third level mode comprises a multiple-level cell (MLC) mode, wherein the number of bits per cell for the MLC mode is two bits per cell, wherein the threshold number of bits in use comprises a first threshold number of bits, and wherein the controller is further configured to: compare the total number of bits in use in each of the cells of the storage access to a second threshold number of bits in use in each of the cells of the storage access; and based on the comparison, reconfigure one or more cells in the storage access for the virtual machine to be in the first level mode, wherein the one or more cells in the storage access being configured in the first level mode comprises each of the cells in the storage access having the maximum allowable number of bits per cell.

### Example 16

The storage device of any of examples 14-15, wherein the virtual machine comprises a first virtual machine, wherein the controller is further configured to: determine a maximum amount of storage access for a second virtual machine on the SSD when each of the cells in the storage access is configured in the first level mode; configure each of the cells in the storage access for the second virtual machine to be in the third level mode; receive a request from a host device to access the SSD; determine a guest level for the host device; and assign the host device to one of the first virtual machine or the second virtual machine based at least in part on the guest level for the host device.

### Example 17

The storage device of any of examples 14-16, wherein the first level mode comprises a quad-level cell (QLC) mode, wherein the maximum allowable number of bits per cell for the QLC mode is equal to four bits per cell, wherein the second level mode comprises a single-level cell (SLC) mode, wherein the number of bits per cell for the SLC mode is one bit per cell, wherein the third level mode comprises a multiple-level cell (MLC) mode, wherein the number of bits per cell for the MLC mode is two bits per cell, wherein the threshold number of bits in use comprises a first threshold number of bits, and wherein the controller is further configured to: compare the total number of bits in use in each of the cells of the storage access to a second threshold number of bits in use in each of the cells of the storage access; based on the comparison, reconfigure one or more cells in the storage access for the virtual machine to be in a fourth level mode, wherein the one or more cells in the storage access being configured in the fourth level mode comprises each of the cells in the storage access having a number of bits per cell greater than the number of bits per cell for the third level mode, wherein the fourth level mode comprises a triple-level cell (TLC) mode, and wherein the number of bits per cell for the TLC mode is three bits per cell; compare the total number of bits in use in each of the cells of the storage access to a third threshold number of bits in use in each of the cells of the storage access; and based on the comparison, reconfigure one or more cells in the storage access for the virtual machine to be in the first level mode, wherein the one or more cells in the storage access being configured in the first level mode comprises each of the cells in the storage access having the maximum allowable number of bits per cell.

### Example 18

The storage device of any of examples 14-17, wherein the storage access comprises a first storage access, wherein the SSD comprises a plurality of blocks, wherein the controller is further configured to: initially configure the first storage access comprising a first portion of each block of the plurality of blocks to be in the first level mode, wherein the first storage access is associated with a first virtual machine workload; initially configure a second storage access comprising a second portion of each block of the plurality of blocks to be in the second level mode, wherein the second storage access is associated with a second virtual machine workload; and initially configure a third storage access comprising a third portion of each block of the plurality of blocks to be in the third level mode, wherein the third storage access is associated with a third virtual machine workload.

### Example 19

A computer-readable storage medium storing instructions that, when executed, cause a controller of a storage device to: determine a maximum amount of storage access for a virtual machine workload on a solid state drive (SSD) when each of the cells in the storage access is configured in a first level mode, wherein each of the cells in the storage access being configured in the first level mode comprises each of the cells in the storage access having a maximum allowable number of bits per cell; configure each of the cells in the storage access for the virtual machine to be in a second level mode, wherein each of the cells in the storage access being configured in the second level mode comprises each of the cells in the storage access having a number of bits per cell less than the maximum allowable number of bits per cell; determine a total number of bits in use in each of the cells of the storage access; compare the total number of bits in use in each of the cells of the storage access to a threshold number of bits in use in each of the cells of the storage access; and based on the comparison, reconfigure one or more cells in the storage access for the virtual machine to be in a third level mode, wherein the one or more cells in the storage access being configured in the third level mode comprises each of the cells in the storage access having a number of bits per cell greater than the number of bits per cell for the second level mode.

### Example 20

The computer-readable storage medium of example 19, wherein the first level mode comprises a triple-level cell (TLC) mode, wherein the maximum allowable number of bits per cell is equal to three bits per cell, wherein the second level mode comprises a single-level cell (SLC) mode, wherein the number of bits per cell for the SLC mode is one bit per cell, wherein the third level mode comprises a multiple-level cell (MLC) mode, wherein the number of bits per cell for the MLC mode is two bits per cell, wherein the threshold number of bits in use comprises a first threshold number of bits, and wherein instructions further cause the controller to: compare the total number of bits in use in each of the cells of the storage access to a second threshold number of bits in use in each of the cells of the storage access; and based on the comparison, reconfigure one or more cells in the storage access for the virtual machine to be in the first level mode, wherein the one or more cells in the storage access being configured in the first level mode comprises each of the cells in the storage access having the maximum allowable number of bits per cell.

### Example 21

A device comprising means for performing the method of any combination of examples 1-13.

### Example 22

A computer-readable storage medium encoded with instructions that, when executed, cause at least one processor of a computing device to perform the method of any combination of examples 1-13.

### Example 23

A device comprising at least one module operable by one or more processors to perform the method of any combination of examples 1-13.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples of the disclosure have been described. Any combination of the described systems, operations, or functions is contemplated. These and other examples are within the scope of the following claims.

1. A method comprising:
determining, by a controller, a maximum amount of storage access for a virtual machine workload on a solid state drive (SSD) when each cell in the storage access is configured in a first level mode having a maximum allowable number of bits per cell;
configuring, by the controller, each of the cells in the storage access for the virtual machine to be in a second level mode having a number of bits per cell less than the maximum allowable number of bits per cell;
determining, by the controller, a total number of bits in use in each of the cells of the storage access;
comparing, by the controller, the total number of bits in use in each of the cells of the storage access to a threshold number of bits in use in each of the cells of the storage access; and
based on the comparison, reconfiguring, by the controller, one or more of the cells in the storage access for the virtual machine to be in a third level mode having a number of bits per cell greater than the number of bits per cell for the second level mode.

2. The method of claim 1, wherein the first level mode comprises a triple-level cell (TLC) mode, wherein the maximum allowable number of bits per cell is equal to three bits per cell, wherein the second level mode comprises a single-level cell (SLC) mode, wherein the number of bits per cell for the SLC mode is one bit per cell, wherein the third level mode comprises a multiple-level cell (MLC) mode, wherein the number of bits per cell for the MLC mode is two bits per cell,
wherein the storage access comprises a first storage access, wherein configuring each of the cells in the first storage access to be in the second level mode comprises initially configuring each of the cells in the first storage access to be in the SLC mode,
and wherein the method further comprises:
initially configuring, by the controller, a second storage access of the SSD to be in the MLC mode, wherein the second storage access is associated with a second virtual machine workload; and
initially configuring, by the controller, a third storage access of the SSD to be in the TLC mode, wherein the third storage access is associated with a third virtual machine workload,
wherein reconfiguring the first storage access comprises:
responsive to determining that the number of bits in use in each of the cells in the first storage access exceeds the threshold number of bits, reconfiguring, by the controller, each of the cells in the first storage access to be in the MLC mode.

3. The method of claim 1, wherein the first level mode comprises a triple-level cell (TLC) mode, wherein the maximum allowable number of bits per cell is equal to three bits per cell, wherein the second level mode comprises a single-level cell (SLC) mode, wherein the number of bits per cell for the SLC mode is one bit per cell, wherein the third level mode comprises a multiple-level cell (MLC) mode, and wherein the number of bits per cell for the MLC mode is two bits per cell.

4. The method of claim 3, wherein the threshold number of bits in use comprises a first threshold number of bits, the method further comprising:
comparing, by the controller, the total number of bits in use in each of the cells of the storage access to a second threshold number of bits in use in each of the cells of the storage access; and
based on the comparison, reconfiguring, by the controller, one or more cells in the storage access for the virtual machine to be in the first level mode having the maximum allowable number of bits per cell.

5. The method of claim 1, wherein the virtual machine comprises a first virtual machine, the method further comprising:
determining, by the controller, a maximum amount of storage access for a second virtual machine on the SSD when each of the cells in the storage access is configured in the first level mode; and
configuring, by the controller, each of the cells in the storage access for the second virtual machine to be in the third level mode.

6. The method of claim 5, further comprising:
receiving, by the controller, a request from a host device to access the SSD;
determining, by the controller, a guest level for the host device; and
assigning, by the controller, the host device to one of the first virtual machine or the second virtual machine based at least in part on the guest level for the host device.

7. The method of claim 1, wherein reconfiguring the one or more cells comprises:
receiving, by the controller, a request to write data to the storage access;
determining, by the controller, a number of cells required to be in the third level mode in order for the controller to write the received data to the storage access; and
reconfiguring, by the controller, the determined number of cells in the storage access to be in the third level mode.

8. The method of claim 1, wherein reconfiguring the one or more cells comprises:
reconfiguring, by the controller, the entirety of the storage access to be in the third level mode.

9. The method of claim 1, wherein the first level mode comprises a quad-level cell (QLC) mode having the maximum allowable number of bits per cell of four bits per cell, wherein the second level mode comprises a single-level cell (SLC) mode having one bit per cell, wherein the third level mode comprises a multiple-level cell (MLC) mode having two bits per cell, wherein the threshold number of bits in use comprises a first threshold number of bits, and wherein the method further comprises:
comparing, by the controller, the total number of bits in use in each of the cells of the storage access to a second threshold number of bits in use in each of the cells of the storage access; and
based on the comparison, reconfiguring, by the controller, one or more cells in the storage access for the virtual machine to be in a fourth level mode having a number of bits per cell greater than the number of bits per cell for the third level mode.

10. The method of claim 9, wherein the fourth level mode comprises a triple-level cell (TLC) mode having three bits per cell, and wherein the method further comprises:
comparing, by the controller, the total number of bits in use in each of the cells of the storage access to a third threshold number of bits in use in each of the cells of the storage access; and
based on the comparison, reconfiguring, by the controller, one or more cells in the storage access for the virtual machine to be in the first level mode having the maximum allowable number of bits per cell.

11. The method of claim 1, wherein reconfiguring the one or more cells comprises:
reconfiguring, by the controller, the one or more cells during a garbage collection process.

12. The method of claim 1, wherein the storage access comprises a first storage access, wherein the SSD comprises a plurality of blocks, wherein the method further comprises:
initially configuring, by the controller, the first storage access comprising a first portion of each block of the plurality of blocks to be in the first level mode, wherein the first storage access is associated with a first virtual machine workload;
initially configuring, by the controller, a second storage access comprising a second portion of each block of the plurality of blocks to be in the second level mode, wherein the second storage access is associated with a second virtual machine workload; and
initially configuring, by the controller, a third storage access comprising a third portion of each block of the plurality of blocks to be in the third level mode, wherein the third storage access is associated with a third virtual machine workload.

13. The method of claim 1, wherein reconfiguring the one or more cells comprises:
reconfiguring, by the controller, the one or more cells as part of a single root input/output virtualization process.

14. A storage device comprising:
a storage access comprising a plurality of cells; and
a controller configured to:
determine a maximum amount of storage access for a virtual machine workload when each of the cells in the storage access is configured in a first level mode, wherein each of the cells in the storage access being configured in the first level mode comprises each of the cells in the storage access having a maximum allowable number of bits per cell;
configure each of the cells in the storage access for the virtual machine to be in a second level mode, wherein each of the cells in the storage access being configured in the second level mode comprises each of the cells in the storage access having a number of bits per cell less than the maximum allowable number of bits per cell;
determine a total number of bits in use in each of the cells of the storage access;
compare the total number of bits in use in each of the cells of the storage access to a threshold number of bits in use in each of the cells of the storage access; and
based on the comparison, reconfigure one or more cells in the storage access for the virtual machine to be in a third level mode, wherein the one or more cells in the storage access being configured in the third level mode comprises each of the cells in the storage access having a number of bits per cell greater than the number of bits per cell for the second level mode.

15. The storage device of claim 14, wherein the first level mode comprises a triple-level cell (TLC) mode, wherein the maximum allowable number of bits per cell is equal to three bits per cell, wherein the second level mode comprises a single-level cell (SLC) mode, wherein the number of bits per cell for the SLC mode is one bit per cell, wherein the third level mode comprises a multiple-level cell (MLC) mode, wherein the number of bits per cell for the MLC mode is two bits per cell, wherein the threshold number of bits in use comprises a first threshold number of bits, and wherein the controller is further configured to:
compare the total number of bits in use in each of the cells of the storage access to a second threshold number of bits in use in each of the cells of the storage access; and
based on the comparison, reconfigure one or more cells in the storage access for the virtual machine to be in the first level mode, wherein the one or more cells in the storage access being configured in the first level mode comprises each of the cells in the storage access having the maximum allowable number of bits per cell.

16. The storage device of claim 14, wherein the virtual machine comprises a first virtual machine, wherein the controller is further configured to:
determine a maximum amount of storage access for a second virtual machine on the SSD when each of the cells in the storage access is configured in the first level mode;
configure each of the cells in the storage access for the second virtual machine to be in the third level mode;
receive a request from a host device to access the SSD;
determine a guest level for the host device; and
assign the host device to one of the first virtual machine or the second virtual machine based at least in part on the guest level for the host device.

17. The storage device of claim 14, wherein the first level mode comprises a quad-level cell (QLC) mode, wherein the maximum allowable number of bits per cell for the QLC mode is equal to four bits per cell, wherein the second level mode comprises a single-level cell (SLC) mode, wherein the number of bits per cell for the SLC mode is one bit per cell, wherein the third level mode comprises a multiple-level cell (MLC) mode, wherein the number of bits per cell for the MLC mode is two bits per cell, wherein the threshold number of bits in use comprises a first threshold number of bits, and wherein the controller is further configured to:
compare the total number of bits in use in each of the cells of the storage access to a second threshold number of bits in use in each of the cells of the storage access;
based on the comparison, reconfigure one or more cells in the storage access for the virtual machine to be in a fourth level mode, wherein the one or more cells in the storage access being configured in the fourth level mode comprises each of the cells in the storage access having a number of bits per cell greater than the number of bits per cell for the third level mode, wherein the fourth level mode comprises a triple-level cell (TLC) mode, and wherein the number of bits per cell for the TLC mode is three bits per cell;
compare the total number of bits in use in each of the cells of the storage access to a third threshold number of bits in use in each of the cells of the storage access; and
based on the comparison, reconfigure one or more cells in the storage access for the virtual machine to be in the first level mode, wherein the one or more cells in the storage access being configured in the first level mode comprises each of the cells in the storage access having the maximum allowable number of bits per cell.

18. The storage device of claim 14, wherein the storage access comprises a first storage access, wherein the SSD comprises a plurality of blocks, wherein the controller is further configured to:
initially configure the first storage access comprising a first portion of each block of the plurality of blocks to be in the first level mode, wherein the first storage access is associated with a first virtual machine workload;
initially configure a second storage access comprising a second portion of each block of the plurality of blocks to be in the second level mode, wherein the second storage access is associated with a second virtual machine workload; and
initially configure a third storage access comprising a third portion of each block of the plurality of blocks to be in the third level mode, wherein the third storage access is associated with a third virtual machine workload.

19. A computer-readable storage medium storing instructions that, when executed, cause a controller of a storage device to:
determine a maximum amount of storage access for a virtual machine workload on a solid state drive (SSD) when each of the cells in the storage access is configured in a first level mode, wherein each of the cells in the storage access being configured in the first level mode comprises each of the cells in the storage access having a maximum allowable number of bits per cell;
configure each of the cells in the storage access for the virtual machine to be in a second level mode, wherein each of the cells in the storage access being configured in the second level mode comprises each of the cells in the storage access having a number of bits per cell less than the maximum allowable number of bits per cell;
determine a total number of bits in use in each of the cells of the storage access,
compare the total number of bits in use in each of the cells of the storage access to a threshold number of bits in use in each of the cells of the storage access; and
based on the comparison, reconfigure one or more cells in the storage access for the virtual machine to be in a third level mode, wherein the one or more cells in the storage access being configured in the third level mode comprises each of the cells in the storage access having a number of bits per cell greater than the number of bits per cell for the second level mode.

20. The computer-readable storage medium of claim 19, wherein the first level mode comprises a triple-level cell (TLC) mode, wherein the maximum allowable number of bits per cell is equal to three bits per cell, wherein the second level mode comprises a single-level cell (SLC) mode, wherein the number of bits per cell for the SLC mode is one bit per cell, wherein the third level mode comprises a multiple-level cell (MLC) mode, wherein the number of bits per cell for the MLC mode is two bits per cell, wherein the threshold number of bits in use comprises a first threshold number of bits, and wherein instructions further cause the controller to:
compare the total number of bits in use in each of the cells of the storage access to a second threshold number of bits in use in each of the cells of the storage access; and
based on the comparison, reconfigure one or more cells in the storage access for the virtual machine to be in the first level mode, wherein the one or more cells in the storage access being configured in the first level mode comprises each of the cells in the storage access having the maximum allowable number of bits per cell.
